(19) United States
(12) Patent Application Publication
(10) Pub. No.: US 2026/0280698 A1
(43) Pub. Date: Sep. 17, 2026

(54) METHOD AND SYSTEM FOR DISTURBANCE TRACKING AND LOCALIZATION

(71) Applicant: CIENA CORPORATION, Hanover, MD (US)

(72) Inventors: Shahab Oveis Gharan, Ottawa (CA); Kim Byron Roberts, Ottawa (CA)

(73) Assignee: CIENA CORPORATION, Hanover, MD (US)

(21) Appl. No.: 19/076,256

(22) Filed: Mar. 11, 2025

(51) Int. Cl. H04B 10/079; H04B 10/25; H04B 10/61

(52) U.S. Cl. CPC H04B 10/0791; H04B 10/25; H04B 10/6165

(57) ABSTRACT

Aspects of the subject disclosure may include, for example, obtaining phase estimates associated with groups of known symbols in an optical signal that is received over an optical fiber, wherein the groups of known symbols are transmitted at known locations in the optical signal, and performing calculations using the phase estimates to facilitate detection or localization of a disturbance to the optical fiber, wherein the calculations decouple an effect of the disturbance on the phase estimates from effects of one or more of transmitter-related phase noise and receiver-related phase noise on the phase estimates. Other embodiments are disclosed.

### FIELD OF THE DISCLOSURE

The subject disclosure relates to methods and systems for disturbance tracking and localization.

### BACKGROUND

In an optical communication system, identifying the location of a disturbance that occurs along a fiber can facilitate needed repairs and thus improve the overall integrity and performance of the system. K. Roberts et al. U.S. Pat. No. 7,376,358 describes using chromatic dispersion to create a peak of optical power at a desired probing location along a fiber for localizing a nonlinearity. Time of flight information can be used to localize a disturbance that affects both directions of a bidirectional optical link. Implementations of this technique are described in D. Doucet et al. U.S. Pat. No. 9,774,392; Y. Hu et al., “Digital Vibration Detection and Localization using Carrier Laser Phase Noise Retrieval in a Conventional Coherent Transponder,” in Optical Fiber Communication Conference (OFC) 2024, W1B.6 (hereafter “W1B.6”); D. Charlton et al., “Field measurements of SOP transients in OPGW, with time and location correlation to lightning strikes,” in OPTICS EXPRESS 9689, Vol. 25, No. 9, 1 May 2017; and G. A. Wellbrock et al., “Field Trial of Vibration Detection and Localization using Coherent Telecom Transponders over 380-km Link,” in OFC 2021, F3B.2 (hereafter “2021 [2]”), each of which is hereby incorporated by reference herein in its entirety. Co-pending U.S. patent application Ser. No. 18/491,309, entitled “ENHANCED DISTURBANCE E MONITORING AND LOCALIZATION ENABLED BY DIGITAL SIGNAL PROCESSING (DSP)-BASED LASER PHASE NOISE ESTIMATION,” filed on Oct. 20, 2023 and which is hereby incorporated by reference herein in its entirety, identifies additional disturbance monitoring techniques and describes, among other things, a method of disturbance monitoring that involves use of a delay within one arm of an orthogonal signal. Co-pending U.S. patent application Ser. No. 18/454,920, entitled “ENVIRONMENTAL DISTURBANCE DETECTION AND LOCALIZATION USING COHERENT MODEM,” filed on Aug. 24, 2023 and which is hereby incorporated by reference herein in its entirety, describes, among other things, use of the phase of a reference and a carrier frequency to estimate the location of a disturbance.

The following is a listing of additional references (each of which is hereby incorporated by reference herein in its entirety) describing various disturbance monitoring techniques:
Y. Yan et al., “Forward Transmission Based Ultra-Long Distributed Vibration Sensing With Wide Frequency Response,” in JOURNAL OF LIGHTWAVE TECHNOLOGY, VOL. 39, NO. 7, Apr. 1, 2021 (hereafter “2021 [3]”);
Y. Yan et al., “Simultaneous communications and vibration sensing over a single 100-km deployed fiber link by fiber interferometry,” in Optical Fiber Communication Conference (OFC) 2023, W1J.4 (hereafter “2023 [5]”);
J. Tang et al., “Distributed vibration sensing and simultaneous self-homodyne transmission of single-carrier net 5.36 Tb/s signal using 7-core fiber,” in Optical Fiber Communication Conference (OFC) 2024, M2K.1 (hereafter “2024 [7]”);
E. Ip. et al., “Distributed Acoustic Sensing for Datacenter Optical Interconnects using Self-Homodyne Coherent Detection,” in Optical Fiber Communication Conference (OFC) 2022, W1G.4 (hereafter “2022 [9]”);
H. Zhou et al., “Linear Fitting-Based Residual Frequency Offset Compensation in Simultaneous Transmitting and Sensing System Using Coherent Transponders,” in 2023 Asia Communications and Photonics Conference/2023 International Photonics and Optoelectronics Meetings (ACP/POEM), Wuhan, China, 2023, pp. 1-4 (hereafter “2023 [10]”);
H. He et al., “Integrated sensing and communication in an optical fibre,” in Light: Science & Applications (2023) 12:25 (hereafter “2023 [11]”); and
S. Guerrier et al., “Field Trial of High-Resolution Distributed Fiber Sensing over Multicore Fiber in Metropolitan Area with Construction Work Detection using Advanced MIMO-DAS,” in Optical Fiber Communication Conference (OFC) 2023, W1J.5 (hereafter “2023 [12]”).
   FIG. 1D is a table that identifies certain characteristics associated with various techniques described in some of the aforementioned references.

There remains a need for improved methods and systems for low heat disturbance tracking, particularly in high Baud-rate optical transmission systems.

### BRIEF DESCRIPTION OF THE DRAWINGS

Reference will now be made to the accompanying drawings, which are not necessarily drawn to scale, and wherein:

FIG. 1A is a diagram of a non-limiting example of a communication network in accordance with various aspects described herein.

FIG. 1B is a block diagram of an example, non-limiting embodiment of a transmitter/modulator system in accordance with various aspects described herein.

FIG. 1C is a block diagram of an example, non-limiting embodiment of a receiver device in accordance with various aspects described herein.

FIG. 1D is a table that identifies certain characteristics associated with various techniques described in certain aforementioned references.

FIG. 2 is a high-level diagram illustrating phase noise from a fiber disturbance that occurs upstream of receiver (Rx) laser phase noise and downstream of transmitter (Tx) laser phase noise, and that can be tracked by an example disturbance tracker, in accordance with various aspects described herein.

FIG. 3 depicts an illustrative embodiment of a method in accordance with various aspects described herein.

### DETAILED DESCRIPTION

The subject disclosure describes, among other things, illustrative embodiments of an algorithm for tracking/localizing disturbances to an optical fiber. Phase measurements (or measured phase information) of known symbols in known locations in an optical signal that is received over the fiber may be obtained and used in calculations to detect a disturbance. As described in more detail below, the calculations may decouple the effect of the disturbance on the phase measurements from the effects of Tx/Rx laser phase noises on those phase measurements.

Embodiments of the algorithm advantageously facilitate detection of fiber disturbances in the presence of Tx and Rx lasers that have nonideal, low-frequency laser phase noise masks, and provide for low heat disturbance tracking, particularly in high Baud-rate (e.g., frequency division multiplexing (FDM)) optical transmission systems.

One or more aspects of the subject disclosure include a coherent optical receiver comprising a disturbance tracking system that is configured to perform operations. The operations may include obtaining phase estimates associated with groups of known symbols in an optical signal that is received over an optical fiber. Further, the operations may include performing calculations using the phase estimates to facilitate detection or localization of a disturbance to the optical fiber, wherein the calculations decouple an effect of the disturbance on the phase estimates from effects of one or more of transmitter-related phase noise and receiver-related phase noise on the phase estimates.

One or more aspects of the subject disclosure include a non-transitory machine-readable medium, comprising executable instructions that, when executed by a processing system of an optical receiver including a processor, facilitate performance of operations. The operations may include obtaining phase estimates associated with groups of known symbols in an optical signal that is received over an optical fiber. Further, the operations may include performing calculations using the phase estimates to facilitate detection or localization of a disturbance to the optical fiber, wherein the calculations decouple an effect of the disturbance on the phase estimates from effects of one or more of transmitter-related phase noise and receiver-related phase noise on the phase estimates.

One or more aspects of the subject disclosure include a method. The method may include obtaining, by a processing system including a processor, phase estimates associated with groups of known symbols in an optical signal that is received over an optical fiber. Further, the method may include performing, by the processing system, calculations using the phase estimates to facilitate detection or localization of a disturbance to the optical fiber, wherein the calculations decouple an effect of the disturbance on the phase estimates from effects of one or more of transmitter-related phase noise and receiver-related phase noise on the phase estimates.

Other embodiments are described in the subject disclosure.

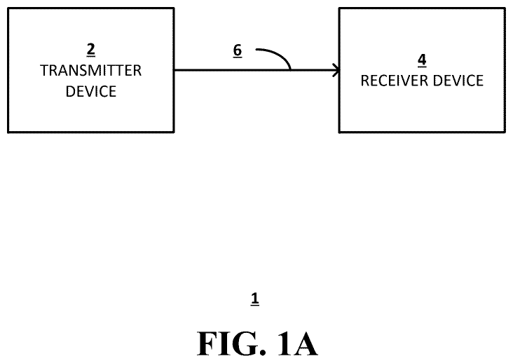

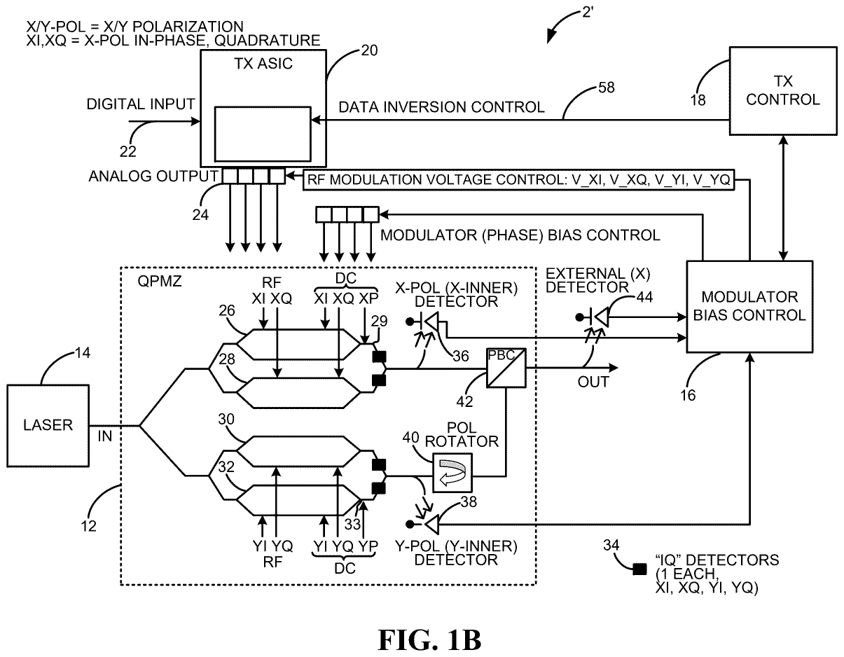

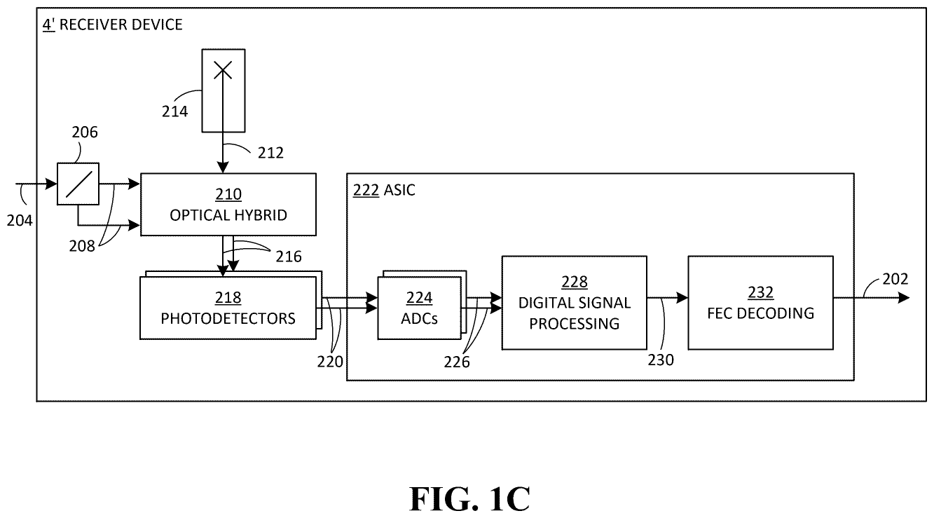

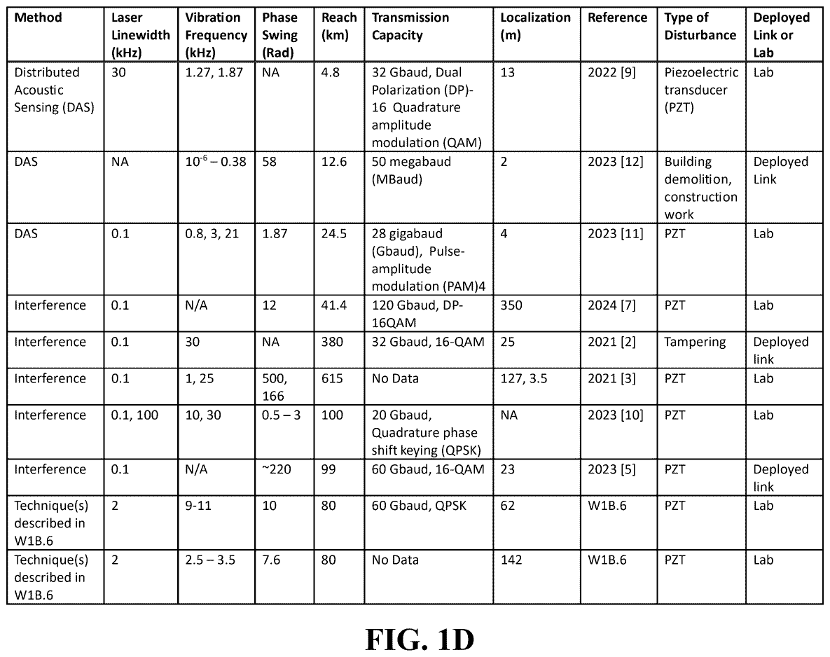

FIG. 1A is a diagram of a non-limiting example of a communication network 1 in accordance with various aspects described herein. The communication network 1 may include at least one transmitter device 2 and at least one receiver device 4. The transmitter device 2 may be capable of transmitting signals over a communication channel, such as a communication channel 6. The receiver device 4 may be capable of receiving signals over a communication channel, such as the communication channel 6. In various embodiments, the transmitter device 2 may also be capable of receiving signals and/or the receiver device 4 may also be capable of transmitting signals. Thus, one or both of the transmitter device 2 and the receiver device 4 may be capable of acting as a transceiver.

The communication network 1 may include additional elements not shown in FIG. 1A. For example, the communication network 1 may include one or more additional transmitter devices, one or more additional receiver devices, and one or more other devices or elements involved in the communication of signals in the communication network 1.

In some embodiments, the signals that are transmitted and received in the communication network 1 may include optical signals and/or electrical signals. For example, the transmitter device 2 may be a first electrical-based transceiver, the receiver device 4 may be a second electrical-based transceiver, and the communication channel 6 may be an electrical communication channel (e.g., a coaxial cable, a printed circuit board (PCB) trace, or the like). For instance, the communication network 1 may include a SerDes system. As another example, the transmitter device 2 may be a first optical transceiver, the receiver device 4 may be a second optical transceiver, and the communication channel 6 may be an optical communication channel. In certain embodiments, one or both of the first optical transceiver and the second optical transceiver may be a coherent modem.

Where the communication network 1 involves the transmission of optical signals, the communication network 1 may include additional optical elements not shown in FIG. 1A, such as wavelength selective switches, optical multiplexers, optical de-multiplexers, optical filters, and/or the like. Furthermore, each optical communication channel in the communication network 1 may include one or more links, where each link may include one or more spans, and where each span may include a length of optical fiber and one or more optical amplifiers.

Various elements and effects in an optical link between two communicating devices may result in the degradation of transmitted signals. That is, optical signals received over optical links can become distorted. Particularly, these signals may suffer from polarization mode dispersion (PMD), polarization dependent loss or gain (PDL or PDG), state of polarization (SOP) rotation, amplified spontaneous emission (ASE) noise, wavelength-dependent dispersion or chromatic dispersion (CD), nonlinear noise from propagation through fiber, and/or other effects. For instance, polarization effects of a fiber link tend to rotate the transmitted polarizations such that, at the receiver, they are neither orthogonal to each other nor aligned with the polarization beam splitter of the optical hybrid. As a result, each of the received polarizations (e.g., downstream of the polarization beam splitter) may contain energy from both of the transmitted polarizations, as well as distortions due to CD, PMD, PDL, etc. These problems may be compounded for polarization-division multiplexed signals in which each transmitted polarization contains a respective data signal. The degree of signal degradation due to noise and nonlinearity may be characterized by a signal-to-noise ratio (SNR) or, alternatively, by a noise-to-signal ratio (NSR). The signals transmitted in the communications network may be representative of digital information in the form of bits or symbols. The probability that bit estimates recovered at a receiver differ from the original bits encoded at a transmitter may be characterized by the Bit Error Ratio (BER). As the noise power increases relative to the signal power, the BER may also increase.

FIG. 1B is a block diagram of an example, non-limiting embodiment of a transmitter/modulator system 2′ in accordance with various aspects described herein. In one or more embodiments, the transmitter/modulator system 2′ may correspond to the transmitter 2 of FIG. 1A. As shown in FIG. 1B, the transmitter device 2′ may include a combination of optical and electrical components, such as, for example, a modulator 12, a laser 14, a modulator bias controller 16, a transmitter (Tx) controller 18, and a Tx application specific integrated circuit (ASIC) 20. The modulator 12 may employ nested Mach-Zehnder (MZ) architecture(s)—i.e., two dual-parallel MZs (DPMZs), each with two inner MZs and one outer MZ—resulting in a quad parallel MZ (QPMZ) modulator.

In one or more embodiments, the optical modulator system 2′ may be equipped to control four quadrature data signals (i.e., radio frequency (RF) XI, RF XQ, RF YI, RF YQ signals, where X, Y denote polarization and I, Q denote in-phase and quadrature, respectively) via the Tx ASIC 20. The modulator 12 may include an XI modulator 26, an XQ modulator 28, and an outer phase modulator 29 (respectively functioning as two inner MZs nested within an outer MZ for the X polarization) as well as a YI modulator 30, a YQ modulator 32, and an outer phase modulator 33 (respectively functioning as two inner MZs nested within an outer MZ for the Y polarization). Each MZ may have one or two direct current (DC) electrodes depending on the implementation of the MZ. The laser 14 may provide a laser output for modulation by the modulator 12. The laser output may be divided (e.g., via a beam splitter) into X and Y polarizations, where the X polarization may be further divided (e.g., via another beam splitter) into an optical I input that is fed into an X-pol I-arm (i.e., the XI modulator 26) and an optical Q input that is fed into an X-pol Q-arm (i.e., the XQ modulator 28), and where the Y polarization may be further divided (e.g., via yet another beam splitter) into an optical I input that is fed into a Y-pol I-arm (i.e., the YI modulator 30) and an optical Q input that is fed into a Y-pol Q-arm (i.e., the YQ modulator 32). The modulator 12 may be capable of independently generating orthogonal optical electric field components (I channel and Q channel) for each polarization X and Y, according to various types of multi-value modulation methods, such as N-quadrature amplitude modulation (QAM), differential quadrature phase shift keying (D-QPSK), etc.

In general operation, the Tx ASIC 20 may receive a digital information stream at a digital input 22 and convert the digital information stream (based on an associated modulation scheme) for driving the modulator 12 via analog outputs 24 (RF XI, RF XQ, RF YI, RF YQ). The analog outputs 24 may be communicatively coupled to the modulator 12. In some embodiments, the Tx ASIC 20 may include a digital filter that provides a transfer function H on the received digital input 22. A digital-to-analog (D/A) converter may be connected to an output of the digital filter, and an analog amplifier may be connected to an output of the D/A converter to provide a gain G. An output of the analog amplifier may provide the analog output 24 to the modulator 12. In certain embodiments, a controller may be connected to the digital filter and the analog amplifier to control the transfer function H and/or the gain G responsive to a data inversion control signal 58 from the Tx controller 18.

A detector 34 (also referred to as a tap-detector) may be included at an output of each of the modulators 26, 28, 30, 32. In certain embodiments, some or all of the modulators 26, 28, 30, 32 may be referred to as inner modulators and can be amplitude, phase, or mixed phase/amplitude modulators. In one or more embodiments, some or all of the modulators 26, 28, 30, 32 may be phase modulators. As shown, the modulator 12 may include an X-polarization detector 36 that is coupled to a combined output of the modulators 26, 28 (or the output of the outer MZ 29), and a Y-polarization detector 38 that is coupled to a combined output of the modulators 30, 32 (or the output of the outer MZ 33). A polarization rotator 40 may be connected to the combined output of the modulators 30, 32. A polarization beam combiner 42 may be connected to the combined output of the modulators 26, 28 and the combined output of the modulators 30, 32. An output of the polarization beam combiner 42 may provide a modulated output of the modulator 12, and an external detector 44 may be tapped off of the output. The various detectors 34, 36, 38, 44 may be communicatively coupled to the modulator bias controller 16.

As shown in FIG. 1B, several modulator bias points of the modulator 12 may be controlled or optimized via the modulator bias controller 16. In some embodiments, the Tx controller 18 may control the Tx ASIC 20 and/or the modulator bias controller 16. In various embodiments, the Tx controller 18 may control the modulator bias controller 16 in the following ways: (i) open loop control where bias control loops can be opened, enabling direct control of biases and measurement of the detectors 34, 36, 38, 44; and/or (ii) closed loop control where the feedback polarity of the modulator bias controller 16 can be set, but where the modulator bias controller 16 itself implements the feedback control. The Tx controller 18 may identify (e.g., optimum) bias points whereas the modulator bias controller 16 may maintain those points in service. In some embodiments, the modulator bias controller 16 may control the generated analog output signals of the Tx ASIC 20, rather than control bias values of the modulator 12.

FIG. 1C is a block diagram of an example, non-limiting embodiment of a receiver device 4′ in accordance with various aspects described herein. In one or more embodiments, the receiver device 4′ may correspond to the receiver 4 of FIG. 1A. In various embodiments, the receiver device 4′ may be configured to receive an optical signal 204, which may comprise a degraded version of an optical signal generated by a transmitter device (e.g., the transmitter device 2′ of FIG. 1B). The optical signal generated by the transmitter device may be representative of information bits (also referred to as client bits) which are to be communicated to the receiver device 4′. The optical signal generated by the transmitter device may be representative of a stream of symbols. According to some examples, the transmitter device may be configured to apply forward error correction (FEC) encoding to the client bits to generate FEC-encoded bits, which may then be mapped to one or more streams of data symbols. The optical signal transmitted by the transmitter device may be generated using any of a variety of techniques, such as frequency division multiplexing (FDM), polarization-division multiplexing (PDM), single polarization modulation, modulation of an unpolarized carrier, mode-division multiplexing, spatial-division multiplexing, Stokes-space modulation, polarization balanced modulation, wavelength division multiplexing (WDM) (where a plurality of data streams is transmitted in parallel, over a respective plurality of carriers, and where each carrier is generated by a different laser), and/or the like.

The receiver device 4′ may be configured to recover corrected client bits 202 from the received optical signal 204. The receiver device 4′ may include a polarizing beam splitter 206 configured to split the received optical signal 204 into polarized components 208. According to one example implementation, the polarized components 208 may include orthogonally polarized components corresponding to an X polarization and a Y polarization. An optical hybrid 210 may be configured to process the components 208 with respect to an optical signal 212 produced by a laser 214, thereby resulting in optical signals 216. Photodetectors 218 may be configured to convert the optical signals 216 output by the optical hybrid 210 to analog electrical signals 220. The frequency difference between the Rx laser and the Tx laser is the Intermediate Frequency, and an offset of that away from nominal can be called f_{IF}. (The nominal difference is usually zero.) According to one example implementation, the analog electrical signals 220 may include four signals corresponding, respectively, to the dimensions XI, XQ, YI, and YQ, where XI and XQ denote the in-phase and quadrature components of the X polarization, and YI and YQ denote the in phase and quadrature components of the Y polarization. Together, elements such as the beam splitter 206, the laser 214, the optical hybrid 210, and the photodetectors 218 may form a communication interface configured to receive optical signals from other devices in a communication network.

As shown in FIG. 1C, the receiver device 4′ may include an ASIC 222. The ASIC 222 may include analog-to-digital converters (ADCs) 224 that are configured to sample the analog electrical signals 220 and generate respective digital signals 226. In certain alternate embodiments, the ADCs 224 or portions thereof may be separate from the ASIC 222. The ADCs 224 may sample the analog electrical signals 220 periodically at a sample rate that is based on a signal received from a voltage-controlled oscillator (VCO) at the receiver device 4′ (not shown). The ASIC 222 may be configured to apply digital signal processing to the digital signals 226 using a digital signal processing system 228. The digital signal processing system 228 may be configured to perform equalization processing that is designed to compensate for a variety of channel impairments, such as CD, SOP rotation, mean PMD that determines the probability distribution which instantiates as differential group delay (DGD), PDL or PDG, and/or other effects. The digital signal processing system 228 may further be configured to perform carrier recovery processing, which may include calculating an estimate of carrier frequency offset f_{IF} (i.e., the difference between the frequency of the transmitter laser and the frequency of the receiver laser 214). According to some example implementations, the digital signal processing system 228 may further be configured to perform operations such as multiple-input-multiple-output (MIMO) filtering, clock recovery, and FDM subcarrier de-multiplexing. The digital signal processing system 228 may also be configured to perform symbol-to-bit demapping (or decoding) using a decision circuit, such that signals 230 output by the digital signal processing system 228 are representative of bit estimates. Where the received optical signal 204 is representative of symbols comprising FEC-encoded bits generated as a result of applying FEC encoding to client bits, the signals 230 may further undergo FEC decoding 232 to recover the corrected client bits 202.

According to some example implementations, the equalization processing implemented as part of the digital signal processing system 228 may include one or more equalizers, some or all of which may be configured to compensate for impairments in the channel response. In general, an equalizer applies a substantially linear filter to an input signal to generate an output signal that is less degraded than the input signal. The filter may be characterized by compensation coefficients which may be incrementally updated from time to time (e.g., every so many clock cycles or every so many seconds) with the goal of reducing the degradation observed in the output signal.

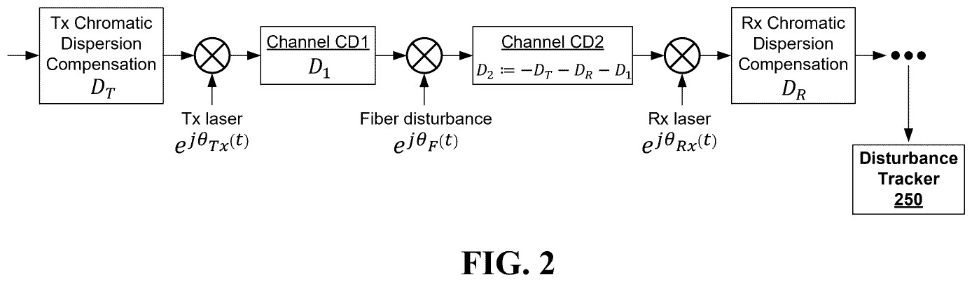

FIG. 2 is a high-level diagram illustrating phase noise from a fiber disturbance that occurs upstream of Rx laser phase noise and downstream of Tx laser phase noise, and that can be tracked by an example disturbance tracker 250, in accordance with various aspects described herein. From the perspective of the Rx following the chromatic dispersion of the fiber downstream of the disturbance, D_{d}, and the Rx CD compensation, D_{R}, the fiber disturbance phase noise experiences a net dispersion that is equal to D_{d}:=D₂+D_{R}. Assuming that the disturbance is not located at the transmitter nor at the receiver, D_{d}≠D_{R}, −D_{T}, it is possible to decouple the source of disturbance to the fiber frequency from the disturbances to both the Tx and Rx laser frequencies. The location of the chromatic dispersion associated with the fiber disturbance source, which can be mechanical, Faraday, or electro-optical, can be estimated based upon such decoupling. It is to be understood and appreciated that the focus here is not on tracking and compensation for equalization enhanced phase noise (EEPN) sources, but rather on the detection of frequency noise disturbances, such as those due to fiber mechanical/vibrational shocks.

The phase noise in the time domain can be identified by obtaining or measuring the phase noises that are associated with known symbols in each FDM subcarrier individually. For purposes of explanation, let us assume an optical communication system that utilizes 4-FDM symbol streams that are equally spaced in frequency. It will be understood and appreciated that the same or similar technique described herein can be used in an N-FDM scenario, where N>2. With some more complexity for sub-band filtering of the signal and of the pattern of known symbols, a similar technique can be used for N=1 or N=2. Focusing on the X-Pol also for the sake of brevity, with the understanding that the same or similar steps may be applied to the Y-Pol, let us denote the received values after Rx chromatic dispersion compensation, clock recovery, and symbol-rate sampling as r_{X,k}[b, m] for the Rx X-pol, where m represents known symbol locations within received block b and k represents the FDM subcarrier. For simplicity of description, the blocks may be Fast Fourier Transform (FFT) blocks after conversion to the time domain. Assume that there are M known symbols per FDM per block b, where s*_{X,k}[m] is the complex conjugate of the m′th known symbol. Four phase noise observations can be obtained from the known symbols of the four FDM subcarriers as follows:

$$∀ k \vert 0 \leq k \leq 4 : {ϕ}_{k} [ b ] := Angle ( {\sum }_{m = 0}^{M} ( {r}_{X , k} [ b , m ] \cdot {s}_{X , k}^{*} [ m ] + {r}_{Y , k} [ b , m ] \cdot {s}_{Y , k}^{*} [ m ] ) )$$

where φₖ[b] represents phase measurements (or measured phase information) that are obtained for block index b and FDM subcarrier k, where r_{X,k}[b, m], r_{Y,k}[b, m] represents the received symbols projected in the X and Y polarizations corresponding to m′th known symbol of FDM subcarrier k and block index b, and where s_{X,k}[b, m], s_{Y,k}[b, m] represents the corresponding known symbol values. For the sake of simplicity, assume that there is no laser Intermediate Frequency (IF), amplified spontaneous emission (ASE), or cross-phase modulation (XPM) phase noise. Due to the chromatic dispersion effect, the phase noise that affects different FDM subcarriers is expected to be delayed with respect to each other. More specifically, the phase noise that affects each FDM subcarrier is expected to be delayed proportionally to the FDM subcarrier position in the spectrum. Let τ_{T}, τ_{R}, and τ_{d} denote the amount of delay (or walk-off) in units of blocks that the phase noise experiences across neighboring FDM subcarriers, corresponding to the transmit laser phase noise, the receive laser phase noise, and the fiber disturbance phase noise. Note that the delay/walk-off values τ_{T}, τ_{R}, and τ_{d} between FDM subcarriers is proportional to the aggregate chromatic dispersion value that each phase noise experiences, which are equal to −D_{T}, D_{R}, and D₂+D_{R}, respectively. The following relationship is to be expected under these simplified assumptions:

$${ϕ}_{k} [ b ] = {θ}_{Tx} ( b + k \cdot {τ}_{T} ) + {θ}_{Rx} ( b - k \cdot {τ}_{R} ) + {θ}_{F} ( b - k \cdot {τ}_{d} )$$

To decouple the received phase estimates, or more particularly inter-FDM phase values, from the Rx laser phase noise, delayed versions of φ₀, φ₂ can be subtracted from the corresponding non-delayed versions of φ₁, φ₃ to arrive at:

$${\tilde{ϕ}}_{0 , 2} [ b ] := {ϕ}_{2} [ b + 2 \cdot {τ}_{R} ] - {ϕ}_{0} [ b ] = {θ}_{Tx} ( b + 2 \cdot ( {τ}_{T} + {τ}_{R} ) ) + {θ}_{F} ( b - 2 \cdot ( {τ}_{d} - {τ}_{R} ) ) - {θ}_{Tx} ( b ) - {θ}_{F} ( b )$$

$${\tilde{ϕ}}_{1 , 3} [ b ] := {ϕ}_{3} [ b + 2 \cdot {τ}_{R} ] - {ϕ}_{1} [ b ] = {θ}_{Tx} ( b + {τ}_{T} + 2 \cdot ( {τ}_{T} + {τ}_{R} ) ) + {θ}_{F} ( b - {τ}_{d} - 2 \cdot ( {τ}_{d} - {τ}_{R} ) ) - {θ}_{Tx} ( b + {τ}_{T} ) - {θ}_{F} ( b - {τ}_{d} )$$

Note that the θ_{Rx} terms have been eliminated.
The contribution from the Tx laser phase noise can then be removed by subtracting a delayed version of \tilde{φ}_{1,3}[b] from \tilde{φ}_{0,2}[b] as follows:

$$\hat{ϕ} [ b ] := {\tilde{ϕ}}_{1 , 3} [ b - {τ}_{T} ] - {\tilde{ϕ}}_{0 , 2} [ b ] = {θ}_{F} ( b ) - {θ}_{F} ( b - {τ}_{T} - {τ}_{d} ) + {θ}_{F} ( b - {τ}_{d} - {τ}_{T} - 2 \cdot ( {τ}_{d} - {τ}_{R} ) ) - {θ}_{F} ( b - 2 \cdot ( {τ}_{d} - {τ}_{R} ) )$$

Now, the θ_{Tx} terms have also been eliminated.
In a case where τ_{d}=−τ_{T} or τ_{d}=τ_{R}, the measure of the fiber disturbance phase noise disappears by virtue of \hat{φ}[b]=0. Otherwise, the fiber disturbance phase noise remains after this elimination of the Tx and Rx laser phase noises. By defining the following relationship:

$${ψ}_{F} ( b ) := {θ}_{F} ( b ) - {θ}_{F} ( b - {τ}_{T} - {τ}_{d} ) = {\int }_{c = b - {τ}_{T} - {τ}_{d}}^{b} {v}_{F} ( c ) \cdot dc$$

where v_{F}(c) represents fiber disturbance frequency noise (rather than phase noise), the final phase estimation can be obtained as follows:

$$\hat{ϕ} [ b ] = {ψ}_{F} ( b ) - {ψ}_{F} ( b - 2 \cdot ( {τ}_{d} - {τ}_{R} ) )$$

Applying the Z-transform thereto reveals a linear transfer function from the (e.g., true) fiber disturbance frequency noise N(z) to the estimated phase \hat{φ}(z) as follows:

$$\hat{Φ} ( z ) = N ( z ) \cdot \frac{1 - {z}^{- {τ}_{T} - {τ}_{d}}}{1 - {z}^{- 1}} \cdot ( 1 - {z}^{- 2 \cdot ( {τ}_{d} - {τ}_{R} )} )$$

Integrating the estimated \hat{φ}[b] to remove the impact of the differentiator results in:

$$\tilde{Φ} ( z ) = N ( z ) \cdot {W}_{{τ}_{T} + {τ}_{d}} ( z ) \cdot {W}_{2 ( {τ}_{d} - {τ}_{R} )} ( z )$$

where W_{c} represents the Z-transform of a rectangular finite impulse response (FIR) filter having width c and a Sinc frequency response. In sum, the frequency response of \tilde{φ}(f) is impacted by the product of two Sinc responses whose widths are determined by the values

$${τ}_{T} + {τ}_{d} and 2 ( {τ}_{d} - {τ}_{R} ) .$$

In view of the derivation above, the following description illustrates how chromatic dispersion at the location of a fiber disturbance can be directly measured—e.g., without any prior knowledge of the frequency mask of the fiber disturbance frequency noise and without the need to evaluate other hypotheses. Here, rather than measuring the differential phase values, the differential phase between two neighboring FDM subcarriers n, n+1 (again, assuming a transmission with four equally spaced FDM subcarriers) that are delayed by τ_{R} from one another can instead be measured as follows to decouple the differential phase value from the Rx laser phase noise:

$$∀ n \vert 0 \leq n \leq 2 : {\tilde{ϕ}}_{n , n + 1} [ b ] := {ϕ}_{n + 1} [ b + {τ}_{R} ] - {ϕ}_{n} [ b ] = {θ}_{Tx} ( b + n \cdot {τ}_{T} + ( {τ}_{T} + {τ}_{R} ) ) + {θ}_{F} ( b - n \cdot {τ}_{d} - ( {τ}_{d} - {τ}_{R} ) ) - {θ}_{Tx} ( b + n \cdot {τ}_{T} ) - {θ}_{F} ( b - n \cdot {τ}_{d} )$$

This assumes that the walk-off values τ_{T}, τ_{R} due to Tx and Rx CD compensation are known. It can be observed that the impact of the Rx laser phase noise is completely removed from the measured phase \tilde{φ}_{n,n+1}[b]. The measured phase can also be decoupled from the Tx laser phase noise by subtracting \tilde{φ}_{n,n+1}[b] from a version of \tilde{φ}_{n+1,n+2}[b] that is delayed by τ_{T}—i.e., by calculating inter-FDM double-differential phase values as follows:

$${\hat{ϕ}}_{0 , 1 , 2} [ b ] := {\tilde{ϕ}}_{1 , 2} [ b - {τ}_{T} ] - {\tilde{ϕ}}_{0 , 1} [ b ] = {θ}_{F} ( b ) + {θ}_{F} ( b - {τ}_{T} - {τ}_{d} - ( {τ}_{d} - {τ}_{R} ) ) - {θ}_{F} ( b - {τ}_{T} - {τ}_{d} ) - {θ}_{F} ( b - ( {τ}_{d} - {τ}_{R} ) )$$

$${\hat{ϕ}}_{1 , 2 , 3} [ b ] := {\tilde{ϕ}}_{2 , 3} [ b - {τ}_{T} ] - {\tilde{ϕ}}_{2 , 1} [ b ] = {θ}_{F} ( b - {τ}_{d} ) + {θ}_{F} ( b - {τ}_{T} - 2 {τ}_{d} - ( {τ}_{d} - {τ}_{R} ) ) - {θ}_{F} ( b - {τ}_{T} - 2 {τ}_{d} ) - {θ}_{F} ( b - {τ}_{d} - ( {τ}_{d} - {τ}_{R} ) )$$

This lends to the following observations. First, the derived phase values \hat{φ}_{0,1,2}[b], \hat{φ}_{1,2,3}[b] are completely decoupled from Tx and Rx laser phase noise sources. Additionally, the derived phase values \hat{φ}_{0,1,2}[b], \hat{φ}_{1,2,3}[b] are delayed versions of one other, i.e.:

$${\hat{ϕ}}_{1 , 2 , 3} [ b ] = {\hat{ϕ}}_{0 , 1 , 2} [ b - {τ}_{d} ]$$

Further, the walk-off value Ta due to the chromatic dispersion at the location of the fiber disturbance can be measured by measuring the time delay between \hat{φ}_{0,1,2}[b], \hat{φ}_{1,2,3}[b]. Moreover, the derived phase values \hat{φ}_{0,1,2}[b], \hat{φ}_{1,2,3}[b] have a transfer function H(z)=(1−z⁻¹)(1+ . . . +z^{-α+1})(1+ . . . +z^{-β+1}) with respect to the fiber disturbance frequency noise, where α=τ_{T}+τ_{d}, β=τ_{d}−τ_{R}. The fiber disturbance frequency noise value can thus be obtained by applying an integrator

$$\frac{1}{1 - {z}^{- 1}}$$

to the phase measurements (or measured phase information).

The following is a brief summary of an example fiber disturbance tracking algorithm that may be implemented in the disturbance tracker 250. The algorithm may include measuring the phase noise φₙ[b] corresponding to each block b and each subcarrier n, where 1≤n≤4. Inter-FDM differential phase noises may be calculated to eliminate the impact of the Rx laser phase noise:

$$∀ n \vert 0 \leq n \leq 2 : {\tilde{ϕ}}_{n , n + 1} [ b ] := {ϕ}_{n + 1} [ b + {τ}_{R} ] - {ϕ}_{n} [ b ]$$

The inter-FDM double-differential phase noises can be calculated to eliminate the impact of the Tx laser phase noise:

$${\hat{ϕ}}_{0 , 1 , 2} [ b ] := {\tilde{ϕ}}_{1 , 2} [ b - {τ}_{T} ] - {\tilde{ϕ}}_{0 , 1} [ b ]$$

$${\hat{ϕ}}_{1 , 2 , 3} [ b ] := {\tilde{ϕ}}_{2 , 3} [ b - {τ}_{T} ] - {\tilde{ϕ}}_{2 , 1} [ b ]$$

The phase values can be integrated to yield fiber disturbance frequency noise values:

$${ψ}_{0} [ b ] := ( 1 - ϵ ) {ψ}_{0} [ b - 1 ] + {\hat{ϕ}}_{0 , 1 , 2} [ b ]$$

$${ψ}_{1} [ b ] := ( 1 - ϵ ) {ψ}_{1} [ b - 1 ] + {\hat{ϕ}}_{1 , 2 , 3} [ b ]$$

where a small value ϵ is a leak for avoiding infinite gain at DC. For instance, Σ≈10/Block_Rate (i.e., corresponding to about 10 Hz) on the assumption that there is little disturbance energy at frequencies below 10 Hz. A low-pass filter h_{LP}[n] may be applied with a 3 decibel (dB) bandwidth f_{3dB}≈100 KHz in order to reduce the impact of ASE noise sources beyond the disturbance frequency as well as to avoid any aliasing noise in a subsequent decimation operation:

$${ψ}_{0 , LP} [ b ] := {ψ}_{0} [ b ] * {h}_{LP} [ n ]$$

$${ψ}_{1 , LP} [ b ] := {ψ}_{1} [ b ] * {h}_{LP} [ n ]$$

The filtered-out signal may be decimated into an f₀~500 KHz signal as follows:

$${ψ}_{0 , Dec} [ b ] := Decimate ( {ψ}_{0 , LP} [ b ] , {f}_{0} )$$

$${ψ}_{1 , Dec} [ b ] := Decimate ( {ψ}_{1 , LP} [ b ] , {f}_{0} )$$

To detect the fiber disturbance, the disturbance power may be integrated using a low-pass filter:

$$p [ b ] := ( 1 - g ) \cdot p [ b - 1 ] + {\vert {ψ}_{0 , Dec} [ b ] \vert}^{2}$$

where the leakage g may be chosen depending on the desired speed for detection of the fiber disturbance. For instance, g≈1000/Block_Rate for detecting events within about a millisecond. A fiber disturbance alarm may be raised based on a threshold Th, i.e., If p[b]>Th, then raise the alarm (e.g., Fiber_Disturbance, where Fiber_Disturbance:=1). In one or more embodiments, the threshold Th may be chosen based on signal size, averaging that may be performed, and/or an amount of noise that is present. For example,

$$Th := 5 \sqrt{\frac{Noise\_power \_variance}{2 g - {g}^{2}}}$$

would have a false alarm about once per hour with the above value of g and white noise.

$$Th := 6 \sqrt{\frac{Noise\_power \_variance}{2 g - {g}^{2}}}$$

would be less sensitive, but have false alarms on the order of once per week. Where the alarm is raised, the time delay between ψ_{0,Dec}[b] and ψ_{1,Dec}[b] may be measured across the interval between blocks Min and Max as follows:

$$τ := \frac{{\sum }_{b = Min}^{Max} {ψ}_{0 , Dec} [ b ] \cdot ( {ψ}_{1 , Dec} [ b + 1 ] - {ψ}_{1 , Dec} [ b - 1 ] )}{2 \cdot ( Max - Min + 1 ) \cdot E \{ {\vert {ψ}_{1 , Dec} \vert}^{2} \}}$$

where the delay is smaller than a two-microsecond update interval (e.g., in a case where the maximum walk-off at 400 nanoseconds (ns)/nanometer (nm) for 50 Gigabaud (Gbaud) FDM streams is about 200 ns). From this measured delay and knowledge of the dispersion of the fiber route, the geographic location of the disturbance can be estimated.

It is to be understood and appreciated that the above-described derivation of the fiber disturbance tracking algorithm relies on simplified assumptions for purposes of brevity and clarity. In practice, numerous variations are possible and thus aspects of the tracking algorithm may be adapted accordingly.

As an example, in various implementations, the disturbance tracking algorithm may utilize measurements that are calculated or obtained by (e.g., existing) frequency estimation systems/hardware, such as one or more of those described in co-pending U.S. patent application Ser. No. 19/014,723, entitled “SYSTEMS AND METHODS FOR EQUALIZATION ENHANCED PHASE NOISE (EEPN) TRACKING AND COMPENSATION,” filed on Jan. 9, 2025 and which is hereby incorporated by reference herein in its entirety and/or co-pending U.S. Patent Application Ser. No. 63/745,833, entitled “SYSTEMS AND METHODS FOR TIME DOMAIN EQUALIZATION ENHANCED PHASE NOISE (EEPN) TRACKING AND COMPENSATION,” filed on Jan. 16, 2025 and which is also hereby incorporated by reference herein in its entirety.

While the disturbance tracking algorithm is implemented such that correlations are made in the time domain, the algorithm can alternatively be implemented such that correlations are made in the frequency domain. For the sake of simplicity, the disturbance tracking algorithm is described herein as involving correlations between individual known symbols, in the time domain, but the correlations can instead be between groups of known symbols across different sub-bands, in the time domain or in the frequency domain. Additionally, while the disturbance tracking algorithm is described with respect to FDM signals, the algorithm can alternatively be implemented using a single stream. While a single symbol in a single stream might not be useful for disturbance detection purposes, a single stream may have energy in multiple (e.g., three or more) frequency sub-bands. Phase measurements associated with groups of symbols in these different sub-bands (e.g., obtained via edgeless clock recovery techniques) can be used in the tracking algorithm to localize disturbances.

Other methods of estimating the delay, such as via correlations or spectral analysis, can additionally or alternatively be used. For simplicity of description, the algorithm described above detects an event and then estimates its location. However, other variations might be desirable. For instance, detections can be isolated to only desired “sensitive” locations. Different kinds of events with different disturbance signatures can be measured, for example, in parallel, or from different locations. Other kinds of measurements can trigger or window the above-described measurement method, or can be triggered by this method. As an example, searching for construction-related disturbances may be done only during working hours. As another example, the detection sensitivity may be increased for an hour after some event is detected on any one of multiple wavelengths on fibers in the same cable. Measurements obtained for multiple wavelengths can also be combined and used.

As some other examples, additive white Gaussian noise (AWGN), other noise, and/or nonlinear degradations, clock jitter, and/or clock phase offset can be present. While discussions above generally focused on the X-pol, the received signal can be dual-polarization. The polarization(s) can also be subject to polarization rotation, polarization dependent loss, and/or polarization mode dispersion.

As some additional examples, Tx digital compensation for chromatic dispersion may or may not be present. The Rx chromatic dispersion compensation might be distributed in multiple functional blocks, or might be combined with other functions such as in digital back propagation. The amount of Rx chromatic dispersion compensation might be low or minimal, with the (e.g., vast) majority of the chromatic dispersion compensation being in the Tx.

As it is also advantageous for the Tx/Rx laser phase noises to be as low as possible, fiber lasers or phase-stabilized lasers can be used. The Tx/Rx laser can have relative intensity noise (RIN), crosstalk, microphonics, power supply ripple, dithers, and/or other imperfections, which the disturbance tracking algorithm may be adapted to account for. Rather than using a laser as the Tx/Rx light source, an extracted optical tone, a comb, or other optical, analog, or digital methods of creating optical mixing products can alternatively be used. Different Tx and Rx lasers may be utilized, and thus these lasers can have different phase noise characteristics. The laser offset frequency (or intermediate frequency (IF)—i.e., f_{IF}) can be near zero or, alternatively, a larger, fixed or variable IF can be used in the system.

With respect to the fiber disturbance itself, it can be geological, acoustic, human-originated, mechanical, Faraday, Raman, Kerr, Brillouin, and/or electro-optical. The disturbance can be a point source or can be distributed across meters or kilometers. The disturbance can be to a fiber or to an optical element, such as a wavelength selective switch (WSS), another type of switch, or an amplifier, that is disposed along a fiber route. The disturbance can be single-shot or periodic. The disturbance can occur to a fiber cable or to an associated item such as a pipeline or electrical cable. The fiber can be a typical transmission fiber or can be configured—e.g., with fiber cross-section(s), grating(s), or mechanical/optical structure(s)—to exhibit enhanced sensitivity to particular disturbances.

It is generally advantageous for the Baud rate to be as high as possible—e.g., 4-FDM with 50 GBaud per FDM, producing a total Baud rate of 200 Gbaud. Adaptations to the disturbance tracking algorithm can, however, be made as appropriate to suit higher or lower Baud rates.

For cost reasons, it is beneficial to utilize Tx and Rx signals that are also carrying data or telecommunications information. However, for improved disturbance tracking speed and/or accuracy, Tx/Rx signals can be mostly or entirely dedicated for disturbance tracking measurement purposes—e.g., most or all of the transmitted symbols may have known values.

With respect to the above-described threshold Th, one or more event detection algorithms can be employed to identify events amidst noise. These may include technique(s) that involve averaging, leaky bucket, and/or matched filtering. The detection can be tailored to specific geographic areas (e.g., over a 10 or 20 km span of fiber) or filtered based on particular spectral characteristics (i.e., signatures) and/or time frames (e.g., only mornings, only afternoons, etc.). Specific sequences of sub-events (e.g., those that repeat five or more times over the course of an hour, etc.) can additionally or alternatively be targeted. Furthermore, detections associated with multiple WDM signals, fibers, cores, and/or directions can be combined for improved accuracy in localizing a common event. Detections can be performed by the transmission equipment (e.g., in the Tx and/or the Rx) or additionally, or alternatively, by a remote server device. Detections can also be in real-time (or near real-time) or based on previously collected data. Satisfaction of an event threshold can trigger the retention and analysis of more detailed or extensive information, such as the micro-second by micro-second polarization or phase values from the Rx.

In certain optical communication system implementations, phase values may be encoded as digital integer codes that correspond to radians. Subtraction operations in the disturbance tracking algorithm—i.e., ordinary signed integer subtractions—would thus be advantageously circular in these implementations. In particular, the correlations in the algorithm may involve the subtraction of phase values that, depending on whether the wrap around is done in one direction or the other, can yield two possible results. The circular subtraction may involve the selection of one of the two results—e.g., the one that has the smaller magnitude.

In various implementations, phase values may be represented using complex numbers, where the radial value indicates the SNR of the signal. In these implementations, subtractions can be effected by way of conjugate multiplies. In general, it is to be understood and appreciated that the disturbance tracking algorithm can be adapted to employ other scalar, vector, or matrix representations and corresponding operations.

The overall hardware unit that might encompass the disturbance tracking process can be single-directional or bidirectional. Aspects of the algorithm can be improved or optimized for heat, such as with a plug (i.e., pluggable optics), or can be improved or optimized for performance as desired. For instance, the performance of the algorithm can be tailored for different amounts of channel CD and/or for different amounts of Tx/Rx low frequency laser frequency noise. Further, the disturbance tracking and location method (e.g., calculation(s) thereof) can be combined with values provided by or obtained via the use of one or more other disturbance detection techniques, such as those briefly mentioned above (see, e.g., FIG. 1D).

The example disturbance tracking algorithm has been described as involving linear operations in which a plurality of first order differences of pairs of phase estimates are calculated, where both parts of a given pair are estimated for known symbols within the same subset of FDMs of a plurality of disjoint subsets of FDMs, and where a second order difference is taken between two of the first order differences. It will be understood and appreciated, however, that other operation(s), whether linear, non-linear, or a combination thereof, that yield substantially equivalent results can alternatively be used in the disturbance tracking algorithm.

It is to be understood and appreciated that, although one or more of FIGS. 1A to 1C and 2 might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various components, devices, systems, modules, circuits, etc. may have been illustrated in one or more of FIGS. 1A to 1C and 2 as separate components, devices, systems, modules, circuits, etc., it will be appreciated that multiple components, devices, systems, modules, circuits, etc. can be implemented as a single component, device, system, module, circuit, etc., or a single component, device, system, module, circuit, etc. can be implemented as multiple components, devices, systems, modules, circuits, etc. Additionally, functions described as being performed by one component, device, system, module, circuit, etc. may be performed by multiple components, devices, systems, modules, circuits, etc., or functions described as being performed by multiple components, devices, systems, modules, circuits, etc. may be performed by a single component, device, system, module, circuit, etc.

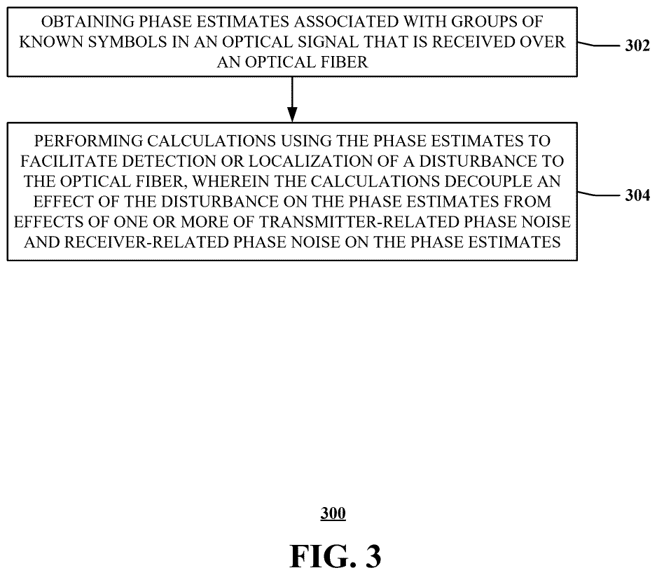

FIG. 3 depicts an illustrative embodiment of a method 300 in accordance with various aspects described herein.

At 302, the method can include obtaining phase estimates associated with groups of known symbols in an optical signal that is received over an optical fiber. For example, the disturbance tracker 250 of a coherent optical receiver, such as the receiver 4′, may, similar to that described above with respect to FIG. 2, perform one or more operations that include obtaining phase estimates associated with groups of known symbols in an optical signal that is received over an optical fiber.

At 304, the method can include performing calculations using the phase estimates to facilitate detection or localization of a disturbance to the optical fiber, wherein the calculations decouple an effect of the disturbance on the phase estimates from effects of one or more of transmitter-related phase noise and receiver-related phase noise on the phase estimates. For example, the disturbance tracker 250 of a coherent optical receiver, such as the receiver 4′, may, similar to that described above with respect to FIG. 2, perform one or more operations that include performing calculations using the phase estimates to facilitate detection or localization of a disturbance to the optical fiber, wherein the calculations decouple an effect of the disturbance on the phase estimates from effects of one or more of transmitter-related phase noise and receiver-related phase noise on the phase estimates.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc. Furthermore, the use of the term approximating or approximation herein can include or involve satisfying particular thresholds in whole or in part.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments. Additionally, functions described as being performed by one component or system may be performed by multiple components or systems, or functions described as being performed by multiple components or systems may be performed by a single component or system, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A coherent optical receiver, comprising:
a disturbance tracking system that is configured to perform operations, including
obtaining phase estimates associated with groups of known symbols in an optical signal that is received over an optical fiber, and
performing calculations using the phase estimates to facilitate detection or localization of a disturbance to the optical fiber, wherein the calculations decouple an effect of the disturbance on the phase estimates from effects of one or more of transmitter-related phase noise and receiver-related phase noise on the phase estimates.

2. The coherent optical receiver of claim 1, wherein the optical signal includes N≥3 frequency sub-bands, and wherein the groups of known symbols have energy in the N frequency sub-bands.

3. The coherent optical receiver of claim 2, wherein the N frequency sub-bands comprise N frequency division multiplexing (FDM) symbol streams, and wherein the groups of known symbols are transmitted at known locations within the N FDM symbol streams.

4. The coherent optical receiver of claim 2, wherein N is equal to four or eight.

5. The coherent optical receiver of claim 1, wherein the optical signal includes only a single stream of symbols.

6. The coherent optical receiver of claim 1, wherein the transmitter-related phase noise comprises a transmitter laser phase noise, and wherein the receiver-related phase noise comprises a receiver laser phase noise.

7. The coherent optical receiver of claim 1, wherein the calculations comprise one or more linear operations, one or more non-linear operations, or a combination thereof.

8. The coherent optical receiver of claim 1, wherein the calculations involve pair-wise phase estimate differences.

9. The coherent optical receiver of claim 8, wherein the calculations involve second order differences between distinct pair-wise phase estimate differences.

10. The coherent optical receiver of claim 8, wherein the differences are represented as angles or complex values.

11. The coherent optical receiver of claim 8, wherein the differences are calculated using one or more conjugate multiplication operations.

12. The coherent optical receiver of claim 8, wherein the differences are calculated from phase estimates obtained across different frequency division multiplexing (FDM) subcarriers of a multi-subcarrier signal.

13. The coherent optical receiver of claim 1, wherein one or more of the groups of known symbols repeat periodically or have a known sequence of length that is greater than four.

14. The coherent optical receiver of claim 1, wherein one or more of the groups of known symbols are dual-polarization complex.

15. The coherent optical receiver of claim 1, wherein a symbol rate associated with the optical signal is at least 20 Gbaud, at least 40 Gbaud, or at least 180 Gbaud.

16. The coherent optical receiver of claim 1, wherein an amount of chromatic dispersion associated with the optical fiber is greater than ten picoseconds (ps) per nanometer (nm).

17. The coherent optical receiver of claim 1, wherein the effect of the disturbance comprises a phase effect.

18. The coherent optical receiver of claim 1, wherein the disturbance is mechanical, acoustic, or a combination thereof.

19. A non-transitory machine-readable medium, comprising executable instructions that, when executed by a processing system of an optical receiver including a processor, facilitate performance of operations, the operations comprising:
obtaining phase estimates associated with groups of known symbols in an optical signal that is received over an optical fiber; and
performing calculations using the phase estimates to facilitate detection or localization of a disturbance to the optical fiber, wherein the calculations decouple an effect of the disturbance on the phase estimates from effects of one or more of transmitter-related phase noise and receiver-related phase noise on the phase estimates.

20. A method, comprising:
obtaining, by a processing system including a processor, phase estimates associated with groups of known symbols in an optical signal that is received over an optical fiber; and
performing, by the processing system, calculations using the phase estimates to facilitate detection or localization of a disturbance to the optical fiber, wherein the calculations decouple an effect of the disturbance on the phase estimates from effects of one or more of transmitter-related phase noise and receiver-related phase noise on the phase estimates.
